(19) United States
(12) Patent Application Publication
(10) Pub. No.: US 2009/0083414 A1
(43) Pub. Date: Mar. 26, 2009

(54) Method and System for Monitoring and Analyzing Peer-to-Peer Users' Activities over a Data Network

(75) Inventors: Alexander Lazovsky, Petach Tikvah (IL); Camuel Gilyadov, Petach Tikvah (IL); Alexander Zaidelson, Kiryat Ono (IL); Ilya Pashkovsky, Rishon LeZion (IL); Jhanna Lazovsky, Petach Tikvah (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: NETBARRAGE LTD., Petach Tikva (IL)

(21) Appl. No.: 11/916,352

(22) PCT Filed: Jun. 5, 2006
(86) PCT No.: PCT/IL2006/000650

§ 371 Date: Jul. 7, 2008

Related U.S. Application Data
(60) Provisional application No. 60/595,089, filed on Jun. 6, 2005.

(51) Int. Cl. G06F 15/173

(52) U.S. Cl. 709/224

(57) ABSTRACT

The present invention relates to a method and system for monitoring peer-to-peer traffic over a data network, comprising (a) file identifier unit (105) for searching the peer-to-peer network (126) according to search criteria, and retrieving identifiers of files that are shared over said peer-to-peer network (126); (b) an enabler (110) for receiving from said filed identifier unit said found identifiers, a for each identifier found, search said peer-to-peer network and finding the network addresses related to computers that contain in their shared storage at least a portion of the file corresponding to said identifier; and (c) a database (111) for storing for each of said identifiers of the network said enabler. The system further comprises an analyzing unit for analyzin (112) and processing data stored within the database, and creating matrixes representing data of peer-to-peer user's activities.

### FIELD OF THE INVENTION

The present invention relates to peer-to-peer networks. More particularly, the invention relates to a method and system for monitoring and analyzing activities of peer-to-peer users over a data network.

### DEFINITIONS, ACRONYMS AND ABBREVIATIONS

Throughout this specification, the following definitions are employed:

Peer-To-Peer Network (or P2P): is a computer network in which each workstation has equivalent capabilities and responsibilities. This differs from client/server conventional networks, in which some computers are dedicated to serving the others. Peer-to-peer networks are generally simpler, but they usually do not offer the same performance under heavy loads. P2P computer network relies on the computational power and bandwidth of the participants in the network rather than on a relatively low number of servers, as conventional networks do. P2P networks are useful for many purposes, such as sharing content files containing audio, video and any other types of data in a digital format.

RIPE: is a short for Réseaux IP (Internet Protocol) Européens that is a forum open to all parties with an interest in the technical development of the Internet.

Socket: A socket, such as the Internet socket is a software abstraction, designed to provide a standard application programming interface (API) for sending and receiving data across a computer network. Sockets are designed to accommodate virtually any networking protocol, though in practice are used mostly for the internet suite of protocols (such as TCP/IP). Sockets are implemented in many different computer languages and for most operating systems.

WHOIS: is a TCP-based (Transmission Control Protocol) query/response protocol, which is widely used for querying a database in order to determine the owner of a domain name, an IP address, etc. The WHOIS system originated as a method that system-administrators could use to look up information for contacting other IP address or domain name administrators (almost like a “white pages”). The use of the data that is returned from query responses has evolved from those origins into a variety of usages, such as Certificate Authority validating the registration for ecommerce https or unsolicited email campaigns.

### BACKGROUND OF THE INVENTION

At the last decade, peer-to-peer file sharing has become a major application of broadband home network connections. Nowadays, it is estimated that more than 60 million Americans use various peer-to-peer file sharing applications/software, and more than 400 millions of people worldwide do so. There are a number of conventional peer-to-peer network protocols, such as BitTorrent, ED2K, FastTrack, Gnutella, Overnet, etc. Each of the protocols has a number of corresponding peer-to-peer file-sharing applications/software that uses it. For example, FastTrack is used by Kazaa™ and Kazaa Lite™ software, ED2K is used by eMule and eDonkey™ software, etc. The P2P file-sharing networks are anonymous; therefore, registering and joining for each of them does not require verified identification data. The P2P network automatically assigns each new user with a unique identifier, and as a result, the new user becomes a part of the corresponding P2P network. In addition, each file within each P2P network is also assigned with its unique identifier, which is a hash code calculated by implementing a hash function (such as SHA-1(Secure Hash Algorithm-1), MD5 (Message-Digest algorithm 5), etc.) on the file contents. The files identifiers are usually generated by means of dedicated hash functions/algorithms (generally, a hash function/algorithm is used for examining the input data and producing an output of a fixed length).

As various researches show, at least 80% of all P2P traffic is generated by at most 20% of files transferred by means of peer-to-peer networks. In most peer-to-peer file-sharing networks, the network addresses related to computers that share and/or download files over a P2P network are available to everyone connected to the network. Usually, when a user starts downloading a file, the file is automatically shared to other users over the network, even though the user does not have the file in full. Furthermore, the search facilities of most P2P file-sharing networks make it possible for any user to find other users, who either are sharing the full file or are in process of downloading that file.

Due to a large number of the P2P traffic over a data network, such as the Internet, there is a need to monitor such traffic and derive useful information. For example, by monitoring the P2P traffic and obtaining information about files that are shared among P2P users, targeted advertising can be provided to each P2P user. Also, can be determined popularity of each shared file along with a geographic location of P2P users, and then can be found a connection between files popularity and the corresponding geographic locations.

The prior art has failed to provide an efficient solution for monitoring P2P traffic over a data network. For example, US 2004/0098370, discloses a system that includes a computer coupled to a database and a network; the computer including an interception device, is adapted to make a copy of a plurality of search requests from the network; and a transfer device adapted to transfer the plurality of search requests from the computer to the database. Another patent application, US 2005/0163050 presents a method for using pseudonodes in a peer-to-peer network. Each pseudonode comprises an IP address and client ID that is changeable upon the occurrence of a preselected event, and includes a list of one or more searchable data objects. Each pseudonode is programmed for monitoring the network to receive search requests therefrom, to compare each search request with the list of data objects and to respond to such request. Still another patent application, US 2005/0053000 discloses a method for controlling a computer entity to participate in a peer-to-peer network. For each computer entity, the method comprises: operating a peer-to-peer protocol for enabling the computer entity to utilize resources of at least one another computer entity, and for enabling said at least another computer entity to utilize resources of said computer entity; and managing said at least one another computer entity by means of said computer entity. However, these patent applications do not teach providing a method and system for obtaining identifiers of files shared over P2P networks, according to one or more predefined search criteria, and then retrieving network addresses related to computers, which share these files. Furthermore, the prior art does not teach analyzing P2P users' activities over P2P networks and deriving useful information from this analysis. This information can be later used, for example, by 3-rd party companies for providing targeted advertising.

It is an object of the present invention to provide a method and system for monitoring P2P traffic over a data network.

It is another object of the present invention to provide a method and system for analyzing P2P users' activities over a data network, and deriving useful information.

It is still a further object of the present invention to provide a method and system, which are relatively inexpensive.

Other objects and advantages of the invention will become apparent as the description proceeds.

### SUMMARY OF THE INVENTION

The present invention relates to a method and system for monitoring and analyzing activities of peer-to-peer users over a data network.

The system for monitoring peer-to-peer traffic over a data network comprises: (a) a file identifier unit for searching the peer-to-peer network according to search criteria, and retrieving identifiers of files that are shared over said peer-to-peer network; (b) an enabler for receiving from said file identifier unit said found identifiers, and for each identifier found, searching said peer-to-peer network and finding the network addresses related to computers that contain in their shared storage at least a portion of the file corresponding to said identifier; and (c) a database for storing for each of said files the identifiers of the network addresses found as received from said enabler.

Preferably, the database further stores one or more of the following: (a) geographic locations of computers related to the network addresses found; (b) names of files being shared among peer-to-peer users; (c) identifiers of files being shared among peer-to-peer users; (d) nicknames of peer-to-peer users; (e) timestamps; and (f) unique identifiers of peer-to-peer users.

Preferably, the system further comprises an analyzing unit for analyzing and processing data stored within the database.

Preferably, the analyzing unit further creates one or more matrixes representing data of peer-to-peer users' activities.

Preferably, each matrix has two or more dimensions.

Preferably, each matrix dimension represents one or more data contents or one or more types of data contents.

Preferably, for each two or more data contents presented in a row(s) and in a corresponding column(s) of the matrix, the percentage or number of peer-to-peer users, whose activities relate to said two or more data contents, is determined.

Preferably, the system further comprises a geographic locations detection software component connected to the database for analyzing each network address found, and determining the geographic locations of the computers each of which relate to the corresponding network address.

Preferably, the geographic locations detection software component is further provided within the Enabler.

Preferably, the geographic locations detection software component is further provided within a server that comprises the database.

Preferably, the enabler further finds at the peer-to-peer network only network addresses related to computers that are connected to one or more served Internet Services Providers servers.

Preferably, each network address further comprises a port number.

Preferably, the network address is the Transmission Control Protocol/Internet Protocol address or User Datagram Protocol address.

Preferably, the file identifier unit is updated regularly.

Preferably, the file identifier unit is updated automatically by using an external data source.

Preferably, the files identifiers are stored in different formats within the file identifier unit, according to the corresponding peer-to-peer networks in which these files are shared.

Preferably, the enabler is implemented by software, or by hardware, or by a combination thereof.

Preferably, the file identifier unit further comprises: (a) a peer-to-peer networks search server for searching the peer-to-peer network according to search criteria provided by an operator, and retrieving identifiers of files that are shared among peer-to-peer users over said peer-to-peer network; and (b) one or more databases for storing one or more lists of the files identifiers for each peer-to-peer network.

Preferably, the file identifier unit further comprises a Web server for retrieving the stored one or more files identifiers from said one or more databases and transferring them to the enabler.

Preferably, the enabler further comprises a FIU communicator software component for periodically communicating with the file identifier unit in order to receive the updated list of the files identifiers.

Preferably, the enabler further comprises a task manager software component for creating search tasks, according to data provided by the FIU communicator, said task manager maintaining a list of search tasks and creating one or more virtual clients for serving each search task.

Preferably, the enabler further comprises a search task(s) software component for holding data related to each search task, said data related to one or more virtual clients created for said each search task, a corresponding file identifier and a protocol of the peer-to-peer network, wherein the corresponding search(es) is conducted.

Preferably, the enabler further comprises a state machine(s) software component for representing a behavior of a client in each peer-to-peer network.

Preferably, the enabler further comprises a virtual client(s) software component for holding data related to a corresponding state machine and to the corresponding state of said state machine.

Preferably, the enabler further comprises a protocols configurations software component for holding necessary configuration parameters for each peer-to-peer network.

Preferably, the enabler further comprises a configuration repository for holding the overall configuration of said enabler.

Preferably, the enabler further comprises a networking layer for providing network communication services.

Preferably, the enabler, after retrieving the network addresses related to computers that share at least a portion of the one or more files whose identifiers were retrieved by the file identifier unit, determines a list of all files that are shared by said computers or a list of identifiers of said all files.

Preferably, the enabler further searches the peer-to-peer network and finds network addresses related to computers that share at least a portion of one or more files within the list.

The method for monitoring peer-to-peer traffic over a data network comprises: (a) searching the peer-to-peer network, according to search criteria, by means of a file identifier unit, and retrieving identifiers of files that are shared over said peer-to-peer network; (b) receiving said one or more files identifiers from said file identifier unit by means of an enabler; (c) for each identifier found, searching said peer-to-peer network and finding by means of said enabler the network addresses related to computers that contain in their shared storage at least a portion of the file corresponding to said identifier; and (d) for each of said files, storing in a database the identifiers of the network addresses found.

Preferably, the method further comprises storing within the database one or more of the following: (a) geographic locations of computers related to the network addresses found; (b) names of files being shared among peer-to-peer users; (c) identifiers of files being shared among peer-to-peer users; (d) nicknames of peer-to-peer users; (e) timestamps; and (f) unique identifiers of peer-to-peer users.

Preferably, the method further comprises analyzing and processing data stored within the database by means of an analyzing unit.

Preferably, the method further comprises creating one or more matrixes by means of the analyzing unit, said matrixes representing data of peer-to-peer users' activities.

Preferably, the method further comprises creating matrixes of two or more dimensions each.

Preferably, the method further comprises representing by means of each matrix dimension one or more data contents or one or more types of data contents.

Preferably, the method further comprises determining for each two or more data contents presented in a row(s) and in a corresponding column(s) of the matrix, the percentage or number of peer-to-peer users, whose activities are related to said two or more data contents.

### BRIEF DESCRIPTION OF THE DRAWINGS

In the drawings:

FIG. 1A is a schematic illustration of a system for monitoring and analyzing Peer-To-Peer users' activities over a data network, such as the Internet, according to an embodiment of the present invention;

FIG. 1B is another schematic illustration of a system for monitoring and analyzing Peer-To-Peer users' activities over a data network, according to another embodiment of the present invention;

FIG. 1C is a flow diagram for monitoring and analyzing Peer-To-Peer users' activities over a data network, according to an embodiment of the present invention;

FIG. 2 is a schematic illustration of the FIU architecture, according to an embodiment of the present invention;

FIG. 3A is a schematic illustration of an Enabler, according to an embodiment of the present invention;

FIG. 3B is a flow chart of an Enabler operation, according to an embodiment of the present invention; and

FIG. 4A and FIG. 4B are sample tables created by analyzing and processing data stored within database by means of an Analyzing Unit, according to an embodiment of the present invention.

### DETAILED DESCRIPTION OF THE PREFERRED EMBODIMENTS

Hereinafter, where the term “activity” is mentioned, it should be understood that it refers to downloading, uploading, sharing, searching for, or demonstrating interest by any way in one or more files of any type (or portions of said one or more files) over one or more P2P networks.

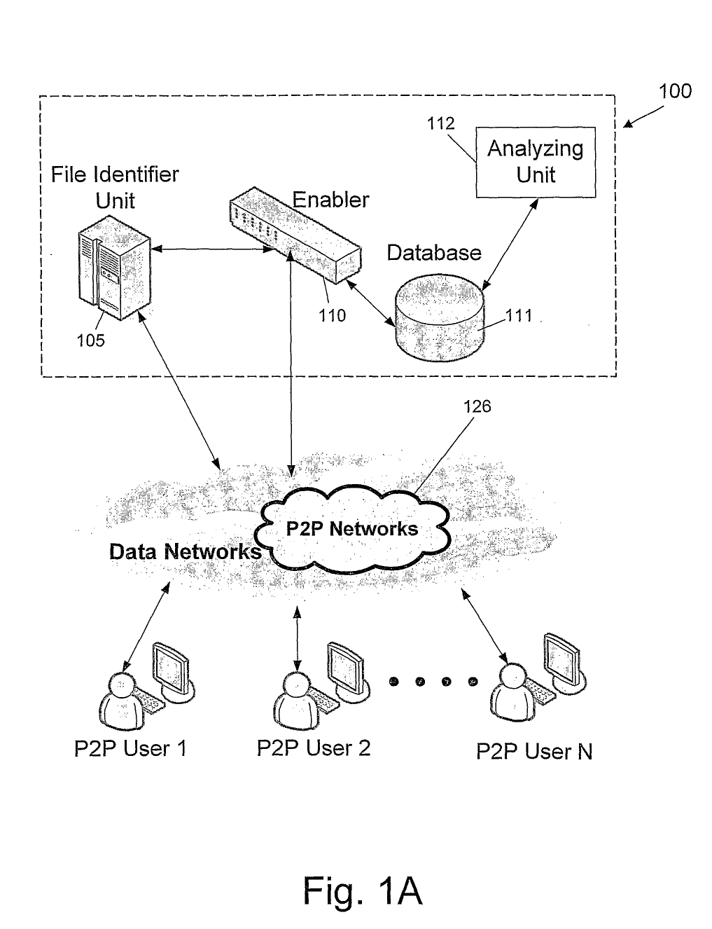

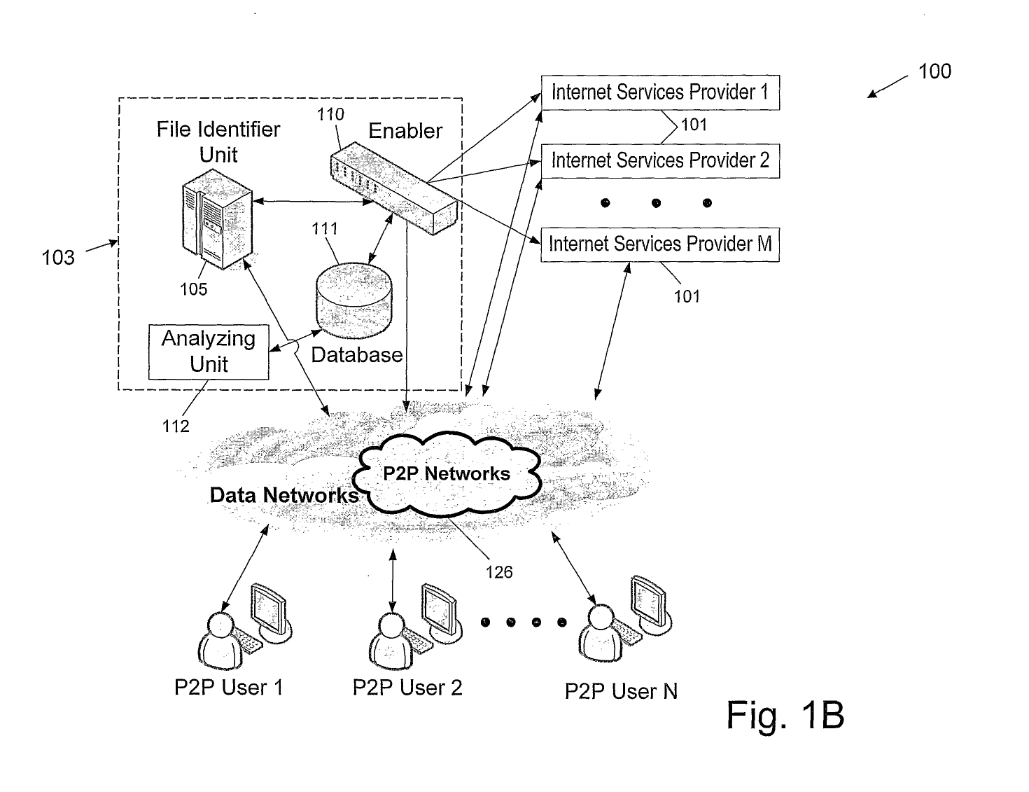

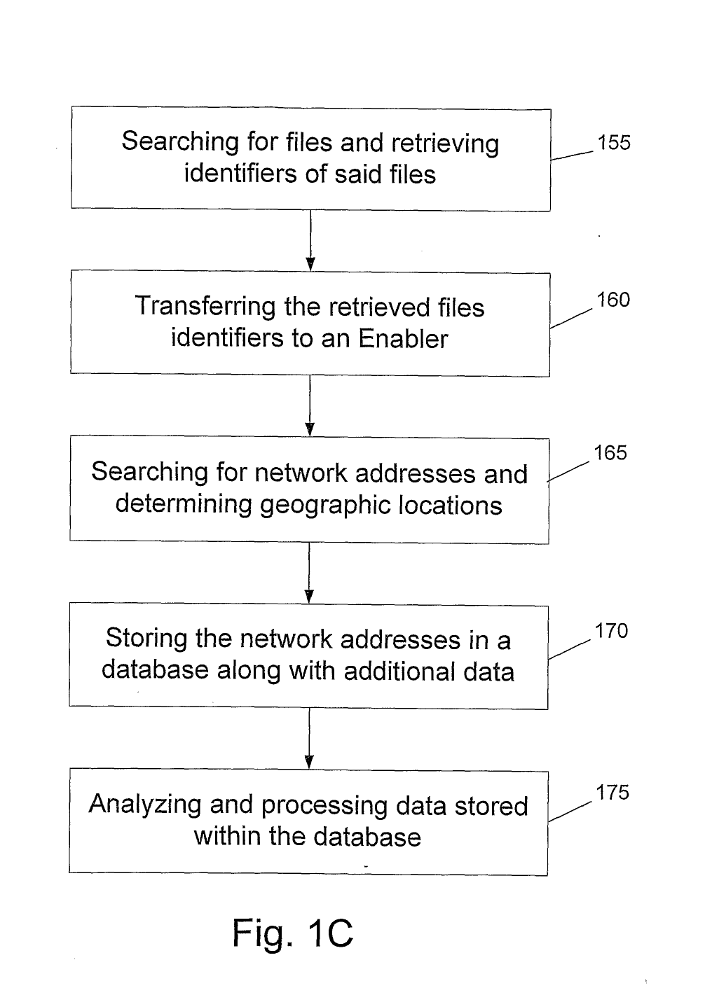

FIG. 1A is a schematic illustration of a system 100 for monitoring and analyzing Peer-To-Peer users' activities over a data network, such as the Internet, according to an embodiment of the present invention. System 100 comprises File Identifier Unit (FIU) 105 for obtaining identifiers of files, which are shared over the P2P network(s) according to one or more predefined search criteria; Enabler 110 for retrieving network addresses related to computers, which share files over the P2P network(s), whose identifier(s) are prior retrieved by FIU 105; a database 111 for storing the retrieved network addresses along with other data obtained by Enabler 110; and Analyzing Unit 112 for analyzing P2P users' activities.

FIU 105 obtains identifiers of files shared over the P2P network(s), according to one or more search criteria provided by an operator (not shown). For example, the operator can instruct FIU 105 to search and obtain identifiers of files, which are the most popular (are the most shared) among P2P users (statistically, 20% of files shared over the P2P network(s) generate most of the traffic). The obtained files identifiers are stored in a database within FIU 105. It should be noted that files identifiers can be stored in different formats, according to the corresponding P2P network(s) in which these files are shared.

According to an embodiment of the present invention, FIU 105 is updated regularly. For example, it can be updated once a day, or once a week.

Enabler 110 is an engine that connects to the P2P network(s), such as BitTorrent, ED2K, FastTrack, Gnutella, Overnet, etc., and for each file, whose identifier is stored within FIU 105, finds corresponding network addresses related to computers that share said each file. When Enabler 110 retrieves from the P2P network(s) the corresponding network addresses related to computers of P2P users, it stores these addresses in database 111. Along with the retrieved network addresses, Enabler 110 stores within said database names of files being shared by the computers related to said network addresses and/or identifiers of said files. In addition, Enabler 110 can determine and store within said database P2P users' nicknames, timestamps, or any other P2P users' data, such as P2P users' unique identifiers. The unique identifiers can be for example, Globally Unique Identifiers (GUIDs), which are pseudo-random numbers used in software applications. In addition, Enabler 110 can determine whether each P2P user has the full file(s) (whose identifier(s) is stored within FIU 105) or he is in a process of downloading it, and then to store the status of file(s) downloading process in said database 111. Furthermore, the data stored in database 111 can comprise additional information, such as names of corresponding P2P protocols and/or names of corresponding P2P applications/software running on the P2P users' computers (by means of which are shared one or more files, whose corresponding identifiers have been found by FIU 105), etc.

According to an embodiment of the present invention, Enabler 110 receives from FIU 105 an initial set of files identifiers. After retrieving network addresses related to computers that share at least a portion of corresponding files (related to said initial set of files identifiers), Enabler 110 retrieves a list of all files which are shared by said computers, and/or a list of identifiers of said all files. In the ED2K protocol, for example, such list can be retrieved from the corresponding computer by means of the conventional “OP_ASKSHAREDFILES” protocol call. In response to this call, the computer returns a list of all files, which are shared by the said computer. Then, Enabler 110 retrieves network addresses related to computers that share at least a portion of the files within said list, and so on. By this way, Enabler 110 retrieves network addresses related to computers, which are sharing files that are also shared by another computer. The above list of files identifiers can be further transferred from Enabler 110 to FIU 105 and stored within said FIU 105.

According to an embodiment of the present invention, after retrieving network addresses, Enabler 110 determines the geographic location (city, country, neighborhood, street, etc.) of each P2P user by analyzing each of said network addresses by means of a geographic locations detection software component, which is connected to database 111. The software component can be provided within Enabler 110, or it can be provided within a server, wherein database 111 is located. For determining the geographic location of the P2P user, the software component queries an IP (Internet Protocol) address database, providing a network address related to the computer of the corresponding P2P user. The IP (Internet Protocol) address database can be, for example, the RIPE (Réseaux IP Européens) WHOIS database, which is provided within the Internet. In response, the software component receives the required geographic location. According to another embodiment of the present invention, a local copy of the WHOIS database is stored within Enabler 110, or within a server, wherein database 111 is located.

By querying database 111, useful information can be obtained. For example, based on the data stored within database 111, a table can be generated, presenting a list of files shared over the P2P network(s) along with a number of users that have shared these files for a predetermined period of time (for example, for a week), and along with the geographic (physical) location of each user. As a result, it can be determined, for example, in which city or country a specific file, which is for example a song, is the most popular. By such way, interests of residents of different cities or countries are determined and used later for different purposes. For example, the record or movie production companies can provide targeted advertisements to the residents of such cities or countries. The data stored in database 111 can be processed in a variety of ways for deriving any useful information.

Analyzing Unit 112 analyzes and processes data stored in database 111 (the data that represents P2P users' activities), and then determines various connections between each activity. For example, can be determined that if User A downloads Spice Girls songs, then he also downloads Britney Spears songs; or if User B downloads action movies, then he also downloads adventure movies. The information determined by Analyzing Unit 112 can be provided, for example, to 3-rd party organizations for targeted advertising based on the determined users' preferences. In the above examples, if a person (who is not necessarily a P2P user) surfs to a shopping Web site and orders a Spice Girls disk, then he will be also advised to purchase a Britney Spears disk; or if a person goes to a DVD (“Digital Versatile Disc”) movie store and buys a disk with an action movie, then he will be also advised to buy an adventure movie.

According to an embodiment of the present invention, Analyzing Unit 112 creates a matrix (table), in which the statistics of P2P users' activities is presented. The matrix can have, for example, two dimensions. Each cell aᵢⱼ within the matrix is represented by a row i and a column j. Each row and column of the matrix relate to the similar or different data contents, such as a song composer, movie producer, song/movie/software category or genre, singer, actor, file type, file size, file identifier, file extension, etc. The content item stored within each cell aᵢⱼ can be the percentage or number of P2P users, whose activities are related to the contents represented by the row i and column j of the matrix. For example, if it was determined that 90 percents of users that download a Spice Girls song(s), also download a Britney Spears song(s), then at the intersection point between the row (column), representing users that download Spice Girls song(s), and the column (row), representing users that download Britney Spears song(s), will be indicated 90% (or 0.9).

According to an embodiment of the present invention, for analyzing data stored within database 111 Analyzing Unit 112 comprises one or more processing tools, such as OLAP (On-Line Analytical Processing) tools, reporting tools, statistical modules, etc. The reporting tools may include OLAP query builder tools, charting tools, etc. OLAP is an approach to quickly provide the answer to analytical queries that are dimensional in nature. It is part of the broader category business intelligence, which also includes ETL (Extract, Transform, and Load), relational reporting and data mining. Databases configured for OLAP employ a multidimensional data model, allowing for complex analytical and ad-hoc queries with a rapid execution time.

It should be noted that the network addresses of the P2P users stored in database 111 can be segmented by means of Analyzing Unit 112 to groups, wherein each group would represent different P2P activity, such as sharing, downloading, searching, etc.

In addition, it should be noted that each network address can be the TCP/IP (Transmission Control Protocol/Internet Protocol) address or UDP (User Datagram Protocol) address, which comprises an IP (Internet Protocol) number and a network port number.

Further, it should be noted that Enabler 110 is implemented by software and/or by hardware.

According to an embodiment of the present invention, Enabler 110 searches the P2P network(s) and processes only network addresses that are related to computers connected to one or more specific ISP (Internet Services Provider) Servers. According to another embodiment of the present invention, Enabler 110 processes all network addresses that relate to computers, which share files, whose identifiers are stored within FIU 105.

It should be noted, that FIU 105 and/or Enabler 110 can be physically located within one or more ISP Servers or can be located separately from said one or more ISP Servers.

FIG. 1B is another schematic illustration of a system 100 for monitoring and analyzing Peer-To-Peer users' activities over a data network, such as the Internet, according to another embodiment of the present invention. According to this embodiment, FIU 105, Enabler 110 and Analyzing Unit 112 provide services to one or more Internet Services Providers 101. Enabler 110 searches the P2P network(s) and processes only network addresses, which relate only to computers connected to the relevant ISPs 101, such as Internet Services Provider 1, Internet Services Provider 2, etc.

It should be noted that according to another embodiment of the present invention, Enabler 110 processes all network addresses related to computers, which perform activities related to files, whose identifiers are stored within FIU 105.

FIG. 1C is a flow diagram for monitoring and analyzing Peer-To-Peer users' activities over a data network, such as the Internet, according to an embodiment of the present invention. At step 155, FIU 105 (FIG. 1A) searches for one or more files shared over the P2P network(s) (according to one or more predefined search criteria), and then retrieves (obtains) the corresponding identifiers of said files from said P2P network(s). Then at step 160, Enabler 110 (FIG. 1A) receives said files identifiers from FIU 105. After that at step 165, for each identifier found, Enabler 110 searches the P2P network(s) and finds network addresses related to computers, which contain in their shared storage at least a portion of the file corresponding to said identifier. Then, for each network address found Enabler 110 determines the geographic location of the corresponding P2P user by analyzing said each network address by means of a software component, which is connected to database 111 (FIG. 1A). The software component can be provided within Enabler 110, or it can be provided within a server, wherein database 111 is located. For determining the geographic location of the P2P user, the software component queries an IP (Internet Protocol) address database, providing a network address related to the computer of the corresponding P2P user. The IP (Internet Protocol) address database can be, for example, the RIPE (Réseaux IP Européens) WHOIS database, which is provided within the Internet. In response, the software component receives the required geographic location. According to another embodiment of the present invention, a local copy of the WHOIS database is stored within Enabler 110, or within a server, wherein database 111 is located. After that at step 170, Enabler 110 stores the found network addresses in database 111 (FIG. 1A) along with the corresponding names of one or more files being shared by computers that relate to said network addresses and/or identifiers of said files, and geographic locations of the corresponding computers. Then, at step 175, the data stored within database 111 is analyzed and processed by means of Analyzing Unit 112. Analyzing Unit 112 creates a matrix (table), in which the statistics of P2P users' activities is presented. The matrix can be, for example, two-dimensional, and each row and column of the matrix can represent files shared by the P2P users. For example, if it was determined that 90 percents of users that download a Spice Girls song(s), also download a Britney Spears song(s), then at the intersection point between the row (column), representing users that download Spice Girls song(s), and the column (row), representing users that download Britney Spears song(s), will be indicated 90% (or 0.9). The matrix can be created in a variety of ways: for example, each column or row of the matrix can represent a song composer, movie producer, song/movie/picture category, singer, actor, file type, file size, file identifier, file extension, etc.

It should be noted that Enabler 110 can determine and store within database 111 P2P users' nicknames, timestamps, or any other P2P users' data and identifiers. In addition, Enabler 110 can determine whether each P2P user has the full file(s) (whose identifier(s) is stored within FIU 105) or he is in a process of downloading it, and then to store the status of file(s) downloading process in said database 111. Furthermore, the data stored in the database can comprise additional information, such as names of corresponding P2P protocols and/or names of corresponding P2P applications/software running on the P2P user's computer (by means of which are shared one or more files, whose corresponding identifiers have been found by FIU 105), etc.

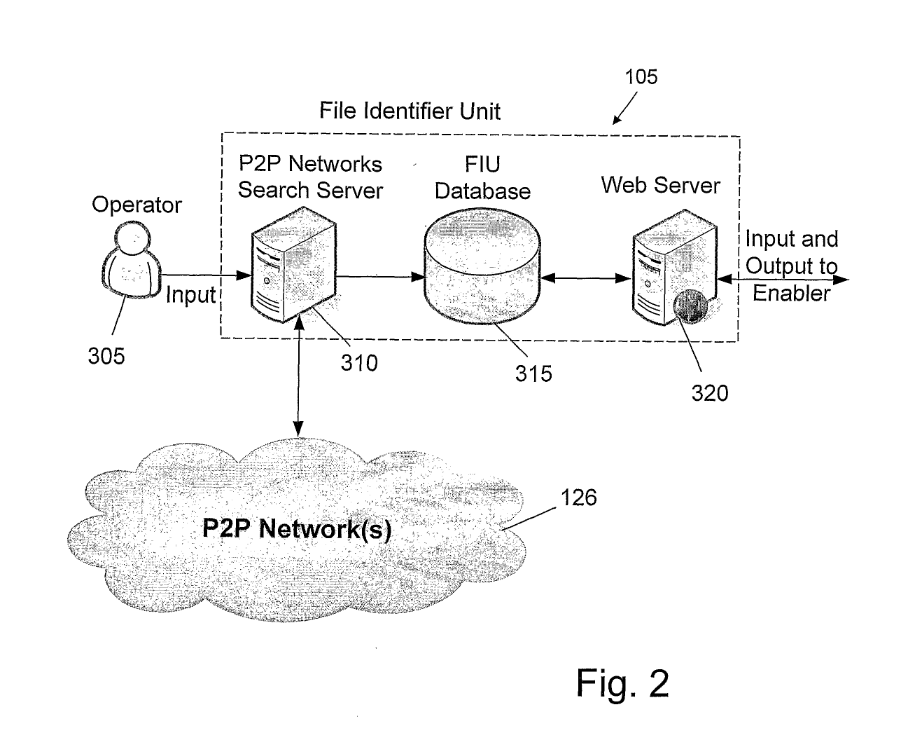

FIG. 2 is a schematic illustration of FIU 105 architecture, according to an embodiment of the present invention. FIU 105 comprises: P2P Networks Search Server 310 for searching and obtaining (retrieving) identifiers of files shared among P2P users over P2P network(s) 126, according to one or more search criteria provided by an operator 305; a FIU Database 315 for storing one or more lists of files identifiers for each P2P network being searched by said P2P Networks Search Server 310; and a Web Server 320 for obtaining (retrieving) the stored files identifiers from said FIU Database 315 and transferring them to Enabler 110 (FIG. 1A).

Operator 305 uses 3rd-party information sources, such as the Internet, advertisements, television to find out new movies, songs, software releases, and etc. Upon obtaining the required information, operator 305 inserts the corresponding search keywords and metadata related to said new movies, songs, ect. into P2P Networks Search Server 310 using a conventional administrative User Interface. The keywords can be, for example, names of new movies, songs, software, etc. For each keyword, additional metadata, such as the type and size of a file(s) representing the corresponding movie, song, or software in the digital format, is also inserted. For example, for a movie titled “ABCD”, the operator can insert: “ABCD” as a keyword; 600 Mb as a minimal file size; and “video” as a file type.

According to an embodiment of the present invention, the search keywords are automatically updated by connecting P2P Networks Search Server 310 to a data source, providing one or more lists of newly released contents (movies, songs, software releases, and etc.). For example, the Internet Movie Database (www.imdb.com) can be used as the external data source for retrieving a list of new movies.

After receiving the required data from operator 305, P2P Networks Search Server 310 conducts one or more search(es) over the corresponding P2P network(s) 126, according to the P2P protocol of each network. P2P Networks Search Server 310 connects to each corresponding P2P network by emulating a P2P network user. Then, it searches for files according to keywords and metadata prior specified by operator 305. As a result, P2P Networks Search Server 310 obtains a list of files, wherein each file is represented by a name and a corresponding file identifier. If the search criteria is: “ABCD” as a keyword; 600 Mb as a minimal file size; and “video” as a file type, then P2P Networks Search Server 310 receives a list of video files, each comprising the word “ABCD” at its name, and each having the size of at least 600 Mb. The list of files is then displayed to operator 305, which can edit it upon the need. In addition, this list is stored within FIU Database 315 for further usage of Enabler 110.

It should be noted that files identifiers can be stored in different formats, according to the corresponding P2P network(s) protocol(s) in which these files are shared.

In addition, it should be noted that FIU Database 315 can be any type of a database, such as a relational database, etc.

Further, it should be noted that P2P Networks Search Server 310, FIU Database 315 and Web Server 320 can be physically located within the same server of FIU 105, or they can be separated and located within different servers.

According to an embodiment of the present invention, FIU 105 is updated regularly. For example, it can be updated once a day, or once a week.

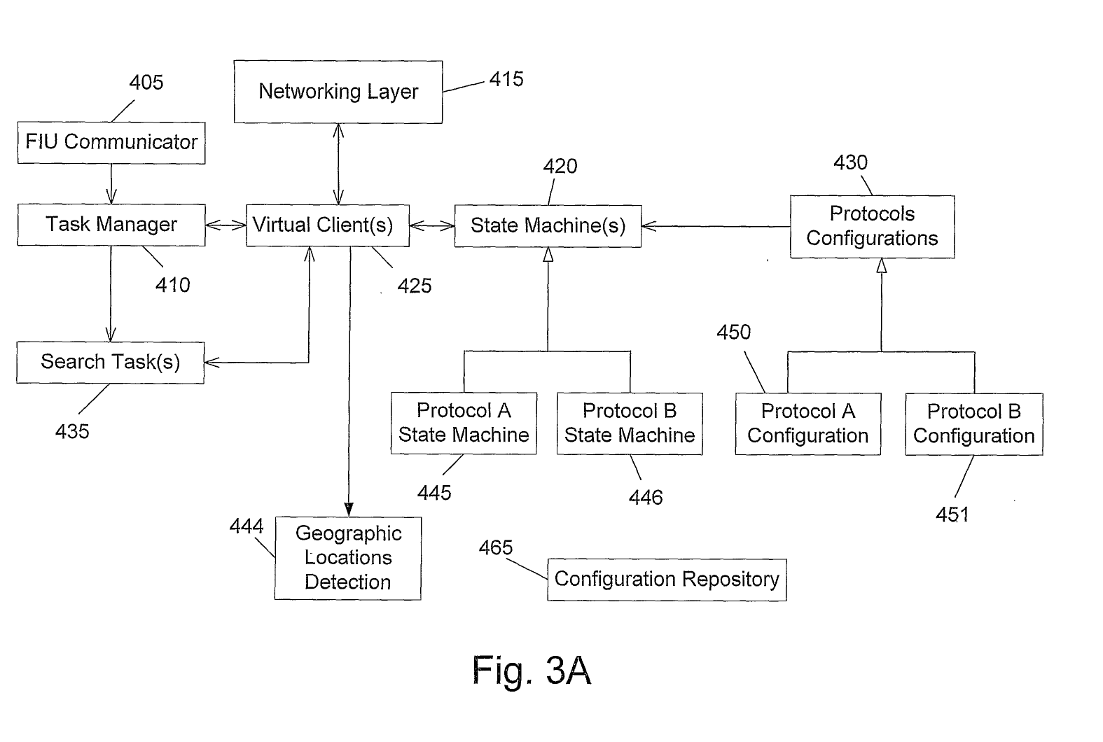

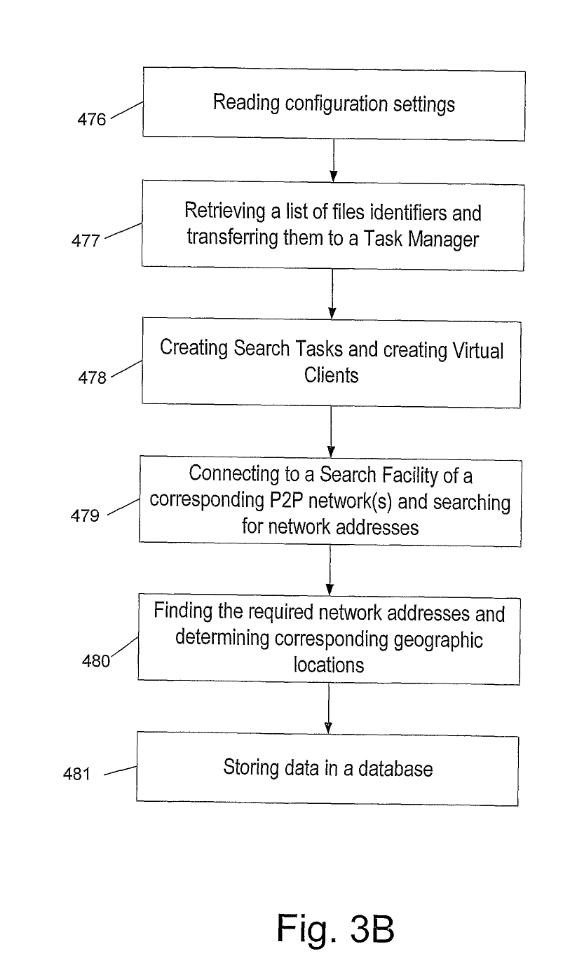

FIG. 3A is a schematic illustration of Enabler 110 (FIG. 1A), according to an embodiment of the present invention. Enabler 110 can be implemented, for example, by means of C and C++ programming languages on a conventional server with the Linux™ operating system (OS).

Enabler 110 comprises the following software components/entities:
(i) a FIU Communicator software component 405 for periodically communicating with FIU 105 (FIG. 1A) in order to receive an updated list(s) of files identifiers.
(ii) a Task Manager software component 410 for creating search task entities, according to data provided by FIU Communicator 405. Task Manager 410 maintains a list of running search tasks and creates virtual clients for serving each search task.
(iii) a Search Task(s) software component 435 for holding data related to each search task, said data related to one or more virtual clients created for that task, a corresponding file identifier and the name and/or protocol of a network, wherein the corresponding search should be conducted.
(iv) a Virtual Client(s) software component 425 for emulating one or more valid P2P clients over the P2P network(s). Each Virtual Client 425 is associated with the corresponding state machine, represented by a State Machine software component 420. For example, if Virtual Client 425 is used for searching the ED2K network, the ED2K_search State Machine 420 is assigned to it. The Virtual Client holds all data related to the corresponding state machine and to the corresponding state of the state machine. The Virtual Client, by means of State Machine(s) software component 420, searches the P2P network(s), according to a search criteria defined by operator 305 (FIG. 3) in FIU 105. Then, the Virtual Client finds and stores the found network addresses (related to computers that share one or more corresponding files) within database 111 (FIG. 1A) along with additional data, such as names of one or more corresponding files and/or files identifiers; P2P users' geographic locations determined by analyzing the found network addresses by means of software component 444; P2P users' nicknames; timestamps; names of corresponding P2P protocols and/or names of corresponding P2P applications/software running on P2P users' computers (by means of which are shared one or more files, whose corresponding identifiers have been found by FIU 105) and any other data. Furthermore, the additional data can comprise an indication whether each P2P user has the full file(s) (whose identifier(s) is stored within FIU 105) or he is in a process of downloading it. Each Virtual Client is associated with a single socket (such as the TCP/IP socket).
(v) a State Machine(s) software component 420 for abstractly representing behavior of a valid client in each P2P network. State Machine software component 420 comprises a set of functions for processing data packets according to a specific P2P protocol (“handling functions”) and a set of functions for creating data packets according to that P2P protocol (“responding functions”). In addition, each State Machine 420 comprises a set of valid states, and it moves between these states by means of said handling and responding functions. For example, for State Machine 420 that emulates the searching behavior of an ED2K client, which connects to an ED2K server, the states can be as follows:
   SRV_CONNECT—the initial state;
   SRV_HELLO_SENT—the connection request is sent to the ED2K server;
   SRV_GETSOURCES_SENT—the request to get the network addresses (related to computers that share certain file) is sent.

The transition between the “SRV_CONNECT” and “SRV_HELLO_SENT” states is performed by means of the “send_hello” function. This function constructs the “HELLO” packet according to ED2K protocol rules and inserts this packet into the buffer (provided within the memory of Enabler 110) for subsequent sending to the corresponding P2P network. After the “HELLO” packet is sent, State Machine 420 moves to the “SRV_HELLO_SENT” state. When the “HELLO_ANSWER” packet arrives, the “hello_answer” handling function called and, after successfully parsing/analyzing the packet, the state machine constructs a “GETSOURCES” packet, inserts it into the buffer for subsequent sending, and moves to the “SRV_GETSOURCES_SENT” state. The “GET_SOURCES” packet comprises a request from the ED2K server to send a list of network addresses related to computers that share one or more corresponding files.
It should be noted that Protocol A State Machine 445 and Protocol B State Machine 446 relate to State Machines according to Protocol A and B, respectively. Protocol A can be, for example, ED2K protocol and Protocol B can be, for example, BitTorrent protocol.
For example, incoming and outgoing calls/functions for client-server communication between peers in the ED2K protocol (which relates to eDonkey™ P2P network) can be the following:
   a. OUT: LOGINREQUEST—this message is sent from a client to the server, indicating that the client wishes to connect to the server;
   b. IN: SERVERMESSAGE—this message is sent from the server to a client, comprising server-specific information, such as the server name.
   c. IN: IDCHANGE—this message is sent from the server to a client, indicating that the client is logged into the server. In addition, this message comprises a new client ID (Identification number), which is assigned to the client by said server;
   d. OUT: GETSOURCES—this message is sent from a client to the server, representing a request for network addresses related to other clients that share specific file(s).
   e. IN: FOUNDSOURCES—this message is sent from the server to a client in response to the above “GETSOURCES” message, containing a list of network addresses related to corresponding clients that share the specific file(s).
(vi) a Protocols Configurations software component 430 for holding necessary configuration parameters for each P2P network. For example, it can comprise a list of addresses for connecting to the BitTorrent, FastTrack and other P2P networks. For the BitTorrent network, the corresponding configuration parameters can be hold, for example, in Protocol A Configuration software component 450, and for FastTrack the corresponding configuration parameters can be hold in Protocol B Configuration software component 451.
(vii) a Configuration Repository 465 for storing the overall configuration of Enabler 110. For example, Configuration Repository 465 can store filters/masks of one or more served ISPs servers (such as ISP Servers 101 (FIG. 1B)), enabling Enabler 110 to distinguish between network addresses related to computers connected to ISP Servers 101 and related to computers that are connected to other ISPs servers. Configuration Repository 465 can also store the network address of Web Server 320 (FIG. 2) to which Enabler 110 needs to connect for retrieving one or more file identifiers. Configuration Repository 465 can be, for example, one or more text files on a hard disk.
(viii) a geographic locations detection software component 444 for analyzing network addresses found by the Virtual Client and determining the geographic location of computers related to said network addresses. For determining the geographic location of the P2P user, the software component queries an IP (Internet Protocol) address database, providing a network address related to the computer of the corresponding P2P user. The IP (Internet Protocol) address database can be, for example, the RIPE (Réseaux IP Européens) WHOIS database, which is provided within the Internet. In response, software component 444 receives the required geographic location. According to another embodiment of the present invention, a local copy of the WHOIS database is stored within Enabler 110, or within a server, wherein database 111 (FIG. 1A) is located. It should be noted that software component 444 can be provided within Enabler 110, or it can be provided within a server, wherein database 111 is located.
(ix) a Networking Layer 415 for providing network communication services. For example, can_read( ) and can_write( ) functions/calls can be used by Networking Layer 415, when data packets arrive or can be sent, respectively. The can_read( ) function assigns each received packet to a specific Virtual Client 425, and then transfers it to said Virtual Client for parsing/analyzing. On the other hand, the can_write( ) function calls the corresponding Virtual Client for writing data to be send over the P2P network (as packets), and sends the corresponding packet(s) over said network.

It should be noted that Networking Layer 415 can be asynchronous or synchronous. According to an embodiment of the present invention, the conventional “/dev/epoll I/O (Input/Output) event notification facility” (as described on http://www.opensourcemanuals.org/manual/epoll/) can be used as asynchronous Networking Layer 415. It is assumed, for the example, that each new socket of the corresponding Virtual Client is registered with the epoll asynchronous Networking Layer 415. Based on the protocol used by the Virtual Client, the socket is also associated with a can_read( ) function that performs the initial parsing of the incoming packets by means of the corresponding Virtual Client. For each P2P protocol, a different canread( ) function can be implemented. In addition, the mapping between the Virtual Clients and their corresponding sockets can be kept, for example, within the memory of Enabler 110.

After Enabler 110 is initialized, the Virtual Clients are created along with their corresponding sockets. Then, each corresponding socket is opened for connecting to a corresponding node (such as ED2K server) within the P2P network. After that, the main program loop starts. In the main loop, the epoll asynchronous Networking Layer 415 is queried. In response, numbers of sockets that are currently available for writing or reading are returned, and the events array is filled within Enabler 110, comprising data related to each of the available sockets. The data comprises an identifier for each socket (for example, a file descriptor in the Unix-based operating system); and the status of the corresponding socket—available for reading or writing. If the socket is available for reading (i.e. data has been sent from the network to that socket) the following flow occurs:
a. can_read( ) function is called, which relates to the protocol used by the corresponding Virtual Client (associated with the socket that is available for reading). For example, the function is ed2k_can_read( ), gnutella_can_read( ), fasttrack_can_read( ), etc.
b. The can_read( ) function performs initial parsing of the packet (by means of the corresponding Virtual Client) in order to verify that the packet is valid, and extracts the protocol verb of the packet. For example, verbs pertaining to the ED2K protocol are:
   a. OP_HELLO;
   b. OP_HELLOANSWER; and
   c. OP_GETSOURCES.
c. Based on the protocol verb, the can_read( ) function calls the corresponding handling function provided within State Machine 420 (associated with the corresponding Virtual Client). The handling functions can be, for example:
   handle_helloanswer( )—handles the incoming “HELLOANSWER” packet;
   handle_searchresult( )—handles the incoming SEARCHRESULTS packet that contains search results;

The handling function performs full parsing of the packet and performs operations, associated with the data provided within the packet. After performing all tasks associated with the packet parsing, the handling function makes a decision what packet should be sent back to the P2P network. This decision is made by selecting a corresponding responding function. The responding functions can be, for example:
respond_helloanswer( )—constructs a “HELLOANSWER” packet in response to the “HELLO” packet sent by a peer within the P2P network;
respond_getsources( )—constructs the “GETSOURCES” packet in response to the received “SEARCHRESULTS” packet. The “GETSOURCES” packet is sent to the ED2K server, requesting to send back a list of network addresses related to computers, in which one or more corresponding files are available for sharing or are currently sharing. The pointer to the responder method is stored in the ptr_responder field within the corresponding Virtual Client, and is called when the socket (related to said corresponding Virtual Client) becomes available for writing.

When the socket is available for writing, then:
The can_write( ) function is called;
The can_write( ) function calls a responding function (pointed by the ptr_responder field of the Virtual Client associated with said socket);
The responding function constructs a packet and inserts it into the buffer; and
The contents of the buffer are provided to the socket related to the corresponding Virtual Client 425.

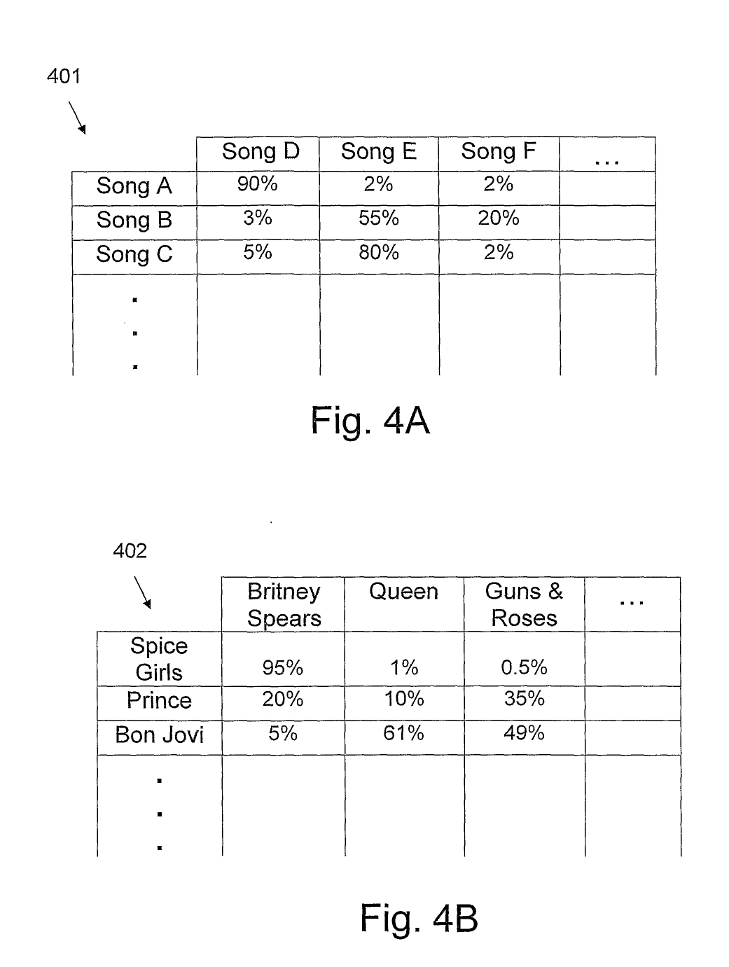

FIG. 3B is a flow chart of Enabler 110 (FIG. 1A) operation, according to an embodiment of the present invention. At step 476, Enabler reads all configuration settings (parameters, list of devices connected to P2P network(s), etc.) from Configuration Repository 465 (FIG. 4A). Configuration Repository 465 can be, for example, one or more text files on a hard disk. Then, at step 477, FIU Communicator 405 (FIG. 4A) calls FIU 105 (FIG. 1A) for retrieving a list of files identifiers from FIU Database 315 (FIG. 3) of said FIU by means of Web Server 320 (FIG. 3) a/long with a type(s) of the P2P protocol(s) of corresponding P2P network(s). Upon obtaining the list, FIU Communicator 405 stores it locally within Enabler 110 for further usage. Then, FIU Communicator 405 calls Task Manager 410 (FIG. 4A) for transferring to it the retrieved files identifiers along with a type(s) of the P2P protocol(s) of the corresponding P2P network(s). At step 478, Task Manager 410 creates corresponding search task(s) 435 (FIG. 4A) (according to files identifiers and the P2P protocols) and creates one or more Virtual Clients 425 (FIG. 4A) for performing these tasks. State machine 420 is assigned to each Virtual Client for representing a behavior of a valid client in the corresponding P2P network. It should be noted, that one or more Virtual Clients can be created per a single task. In addition, each Virtual Client can handle more than one task, for example, searching for network addresses over the P2P network(s) related to computers, which share more than one file. Then, at step 479, each Virtual Client connects to the search facility of the corresponding P2P protocol, such as to the SuperNode in the FastTrack protocol, etc., pretending to be a conventional network client, and searches for network addresses related to computers, which share the corresponding file(s) (specified in the search task(s) of said Virtual Client). At step 480, the Virtual Client finds the required network addresses. In addition, for each network address found Enabler 110 determines the geographic location of the corresponding P2P user by analyzing said each network address by means of software component 444 (FIG. 3A), which is connected to database 111 (FIG. 1A). The software component can be provided within Enabler 110, or it can be provided within a server, wherein database 111 is located. For determining the geographic location of the P2P user, the software component queries an IP (Internet Protocol) address database, providing a network address related to the computer of the corresponding P2P user. The IP (Internet Protocol) address database can be, for example, the RIPE (Réseaux IP Européens) WHOIS database, which is provided within the Internet. In response, software component 444 receives the required geographic location. According to another embodiment of the present invention, a local copy of the WHOIS database is stored within Enabler 110, or within a server, wherein database 111 is located. Then, at step 481, the Virtual Client stores in database 111 (FIG. 4A) network addresses along with corresponding names of one or more files being shared by computers related to said network addresses and/or identifiers of said files, and corresponding geographic locations of P2P users. In addition, the Virtual Client can store in database 111 additional information, such as users' nicknames, timestamps, names of corresponding P2P protocols and/or names of corresponding P2P applications/software running on the P2P user's computer (by means of which are shared one or more files, whose corresponding identifiers have been found by FIU 105), etc.

FIG. 4A and FIG. 4B are sample tables 401 and 402, respectively, created by analyzing and processing data stored within database 111 (FIG. 1A) by means of Analyzing Unit 112 (FIG. 1A), according to an embodiment of the present invention. According to an embodiment of the present invention, Analyzing Unit 112 creates a table (matrix), in which the statistics of P2P users' activities is presented. The table can have, for example, two dimensions. Each cell aᵢⱼ within the table is represented by a row i and a column j. Each row and column of the table relate to the similar or different data contents, such as a song composer, movie producer, song/movie/software category or genre, singer, actor, file type, file size, file identifier, file extension, etc. The content item stored within each cell aᵢⱼ can be the percentage or number of P2P users, whose activities are related to the contents represented by the row i and column j of the table. For example, as shown on FIG. 4A, if it was determined that 90 percents of users that download Song A (which is for example, a Spice Girls song), also download Song D (which is for example, a Britney Spears song), then at the intersection point between the row representing users that download Song A, and the column representing users that download Song D, is indicated 90% (or 0.9). Similarly, on FIG. 4B is presented statistics of downloading songs, sorted by singers. As shown in the table 402, 95% of P2P users who downloaded one or more Spice Girls songs also downloaded one or more Britney Spears songs, and only 1% of the P2P users who downloaded one or more Queen songs also downloaded one or more Spice Girls songs. This information can be provided, for example, to 3-rd party organizations for targeted advertising based on the determined users' preferences. In the above examples, if a person (who is not necessarily a P2P user) surfs to a shopping Web site (or goes to a music store) and orders a Spice Girls disk, then he will be also advised to purchase a Britney Spears disk.

It should be noted that each table (matrix) can be created in a variety of ways. For example, each column or row of the table can represent the following data contents: a song composer, movie producer, song/movie/software category or genre, singer, actor, file type, file size, file identifier, file extension, etc. In addition, it should be noted that each table can be multidimensional, having 3, 4, 5 and more dimensions, and each dimension can represent different data contents, different types of data contents or a combination thereof.

While some embodiments of the invention have been described by way of illustration, it will be apparent that the invention can be put into practice with many modifications, variations and adaptations, and with the use of numerous equivalents or alternative solutions that are within the scope of persons skilled in the art, without departing from the spirit of the invention or exceeding the scope of the claims.

1. A system for monitoring peer-to-peer traffic over a data network, comprising:
a. a file identifier unit for searching the peer-to-peer network according to search criteria, and retrieving identifiers of files that are shared over said peer-to-peer network;
b. an enabler for receiving from said file identifier unit said found identifiers, and for each identifier found, searching said peer-to-peer network and finding the network addresses related to computers that contain in their shared storage at least a portion of the file corresponding to said identifier; and
c. a database for storing for each of said files the identifiers of the network addresses found as received from said enabler.

2. System according to claim 1, wherein the database further stores one or more of the following:
a. geographic locations of computers related to the network addresses found;
b. names of files being shared among peer-to-peer users;
c. identifiers of files being shared among peer-to-peer users;
d. nicknames of peer-to-peer users;
e. timestamps; and
f. unique identifiers of peer-to-peer users.

3. System according to claim 2, further comprising an analyzing unit for analyzing and processing data stored within the database.

4. System according to claim 3, wherein the analyzing unit further creates one or more matrixes representing data of peer-to-peer users' activities.

5. System according to claim 4, wherein each matrix has two or more dimensions.

6. System according to claim 5, wherein each matrix dimension represents one or more data contents or one or more types of data contents.

7. System according to claim 6, wherein for each two or more data contents presented in a row(s) and in a corresponding column(s) of the matrix, the percentage or number of peer-to-peer users, whose activities relate to said two or more data contents, is determined.

8. System according to claim 1, further comprising a geographic locations detection software component connected to the database for analyzing each network address found, and determining the geographic locations of the computers each of which relate to the corresponding network address.

9. System according to claim 8, wherein the geographic locations detection software component is further provided within the Enabler.

10. System according to claim 8, wherein the geographic locations detection software component is further provided within a server that comprises the database.

11. System according to claim 1, wherein the enabler further finds at the peer-to-peer network only network addresses related to computers that are connected to one or more served Internet Services Providers servers.

12. System according to claim 1, wherein each network address further comprises a port number.

13. System according to claim 1, wherein the network address is the Transmission Control Protocol/Internet Protocol address or User Datagram Protocol address.

14. System according to claim 1, wherein the file identifier unit is updated regularly.

15. System according to claim 1, wherein the file identifier unit is updated automatically by using an external data source.

16. System according to claim 1, wherein the files identifiers are stored in different formats within the file identifier unit, according to the corresponding peer-to-peer networks in which these files are shared.

17. System according to claim 1, wherein the enabler is implemented by software, or by hardware, or by a combination thereof.

18. System according to claim 1, wherein the file identifier unit further comprises:
a. a peer-to-peer networks search server for searching the peer-to-peer network according to search criteria provided by an operator, and retrieving identifiers of files that are shared among peer-to-peer users over said peer-to-peer network; and
b. one or more databases for storing one or more lists of the files identifiers for each peer-to-peer network.

19. System according to claim 18, wherein the file identifier unit further comprises a Web server for retrieving the stored one or more files identifiers from said one or more databases and transferring them to the enabler.

20. System according to claim 1, wherein the enabler further comprises a FIU communicator software component for periodically communicating with the file identifier unit in order to receive the updated list of the files identifiers.

21. System according to claim 20, wherein the enabler further comprises a task manager software component for creating search tasks, according to data provided by the FIU communicator, said task manager maintaining a list of search tasks and creating one or more virtual clients for serving each search task.

22. System according to claim 21, wherein the enabler further comprises a search task(s) software component for holding data related to each search task, said data related to one or more virtual clients created for said each search task, a corresponding file identifier and a protocol of the peer-to-peer network, wherein the corresponding search(es) is conducted.

23. System according to claim 1, wherein the enabler further comprises a state machine(s) software component for representing a behavior of a client in each peer-to-peer network.

24. System according to claim 23, wherein the enabler further comprises a virtual client(s) software component for holding data related to a corresponding state machine and to the corresponding state of said state machine.

25. System according to claim 1, wherein the enabler further comprises a protocols configurations software component for holding necessary configuration parameters for each peer-to-peer network.

26. System according to claim 1, wherein the enabler further comprises a configuration repository for holding the overall configuration of said enabler.

27. System according to claim 1, wherein the enabler further comprises a networking layer for providing network communication services.

28. System according to claim 1, wherein the enabler, after retrieving the network addresses related to computers that share at least a portion of the one or more files whose identifiers were retrieved by the file identifier unit, determines a list of all files that are shared by said computers or a list of identifiers of said all files.

29. System according to claim 28, wherein the enabler further searches the peer-to-peer network and finds network addresses related to computers that share at least a portion of one or more files within the list.

30. A method for monitoring peer-to-peer traffic over a data network, comprising:
a. searching the peer-to-peer network, according to search criteria, by means of a file identifier unit, and retrieving identifiers of files that are shared over said peer-to-peer network;
b. receiving said one or more files identifiers from said file identifier unit by means of an enabler;
c. for each identifier found, searching said peer-to-peer network and finding by means of said enabler the network addresses related to computers that contain in their shared storage at least a portion of the file corresponding to said identifier; and
d. for each of said files, storing in a database the identifiers of the network addresses found.

31. Method according to claim 30, further comprising storing within the database one or more of the following:
a. geographic locations of computers related to the network addresses found;
b. names of files being shared among peer-to-peer users;
c. identifiers of files being shared among peer-to-peer users;
d. nicknames of peer-to-peer users;
e. timestamps; and
f. unique identifiers of peer-to-peer users.

32. Method according to claim 31, further comprising analyzing and processing data stored within the database by means of an analyzing unit.

33. Method according to claim 32, further comprising creating one or more matrixes by means of the analyzing unit, said matrixes representing data of peer-to-peer users' activities.

34. Method according to claim 33, further comprising creating matrixes of two or more dimensions each.

35. Method according to claim 34, further comprising representing by means of each matrix dimension one or more data contents or one or more types of data contents.

36. Method according to claim 35, further comprising determining for each two or more data contents presented in a row(s) and in a corresponding column(s) of the matrix, the percentage or number of peer-to-peer users, whose activities relate to said two or more data contents.

37. Method according to claim 30, further comprising analyzing each network address found by means of a geographic locations detection software component connected to the database, and determining by said software component the geographic locations of the computers, each of which relate to the corresponding network address.

38. Method according to claim 37, further comprising providing the geographic locations detection software component within the Enabler.

39. Method according to claim 37, further comprising providing the geographic locations detection software component within a server that comprises the database.

40. Method according to claim 30, further comprising finding by means of the enabler only network addresses related to computers that are connected to one or more served Internet Services Providers servers.

41. Method according to claim 30, further comprising providing within each network address a corresponding port number.

42. Method according to claim 30, further comprising updating the file identifier unit regularly.

43. Method according to claim 30, further comprising automatically updating the file identifier unit by using an external data source.

44. Method according to claim 30, further comprising storing the files identifiers in different formats within the file identifier unit, according to the corresponding peer-to-peer networks in which these files are shared.

45. Method according to claim 30, further comprising implementing the enabler by software, or by hardware, or by a combination thereof.

46. Method according to claim 30, further comprising providing within the file identifier unit:
a. a peer-to-peer networks search server for searching the peer-to-peer network according to search criteria provided by an operator, and retrieving identifiers of files that are shared among peer-to-peer users over said peer-to-peer network; and
b. one or more databases for storing one or more lists of the files identifiers for each peer-to-peer network.

47. Method according to claim 46, further comprising providing within the file identifier unit a Web server for retrieving the stored one or more files identifiers from said one or more databases and transferring them to the enabler.

48. Method according to claim 30, further comprising providing within the enabler a FIU communicator software component for periodically communicating with the file identifier unit in order to receive the updated list of the files identifiers.

49. Method according to claim 48, further comprising providing within the enabler a task manager software component for creating search tasks, according to data provided by the FIU communicator, said task manager maintaining a list of search tasks and creating one or more virtual clients for serving each search task.

50. Method according to claim 49, further comprising providing within the enabler a search task(s) software component for holding data related to each search task, said data related to one or more virtual clients created for said each search task, a corresponding file identifier and a protocol of the peer-to-peer network, wherein the corresponding search(es) is conducted.

51. Method according to claim 30, further comprising providing within the enabler a state machine(s) software component for representing a behavior of a client in each peer-to-peer network.

52. Method according to claim 51, further comprising providing within the enabler a virtual client(s) software component for holding data related to a corresponding state machine and to the corresponding state of said state machine.

53. Method according to claim 30, further comprising providing within the enabler a protocols configurations software component for holding necessary configuration parameters for each peer-to-peer network.

54. Method according to claim 30, further comprising providing within the enabler a configuration repository for holding the overall configuration of said enabler.

55. Method according to claim 30, further comprising providing within the enabler a networking layer for providing network communication services.

56. Method according to claim 30, further comprising determining by means of the enabler, after retrieving the network addresses related to computers that share at least a portion of the one or more files whose identifiers were retrieved by the file identifier unit, a list of all files that are shared by said computers or a list of identifiers of said all files.

57. Method according to claim 56, further comprising searching the peer-to-peer network by means of the enabler and finding network addresses related to computers that share at least a portion of one or more files within the list.
